(19) United States
(12) Patent Application Publication
(10) Pub. No.: US 2006/0227287 A1
(43) Pub. Date: Oct. 12, 2006

(54) Photochromic ophthalmic devices made with dual initiator system

(76) Inventors: Frank Molock, Orange Park, FL (US); Gina M. Cullerton, Jacksonville, FL (US); Shivkumar Mahadevan, Orange Park, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/102,319

(22) Filed: Apr. 8, 2005

(51) Int. Cl. G02C 7/10

(52) U.S. Cl. 351/163

(57) ABSTRACT

The present invention relates to a process comprising exposing a polymerizable mixture comprising at least one lens forming component, at least one thermal initiator, at least one photoinitiator and at least one photochromic compound to device forming conditions comprising heat and actinic radiation to form a photochromic ophthalmic device.

### FIELD OF THE INVENTION

The present invention relates to processes for making ocular devices containing photochromic compounds.

### BACKGROUND OF THE INVENTION

Photochromic spectacles have proven to be successful products which afford the wearer the convenience and improved vision and comfort of visible-light absorbing lenses (sunglasses) when exposed to bright light conditions such as daylight, and return to non-absorbing lenses when in low light conditions to provide optimal night and indoor vision, without the need for switching between two pairs of spectacles.

Contact lenses provide comfort, convenience and excellent vision correction to many consumers. Even though many contact lenses contain UV absorbers, sunglasses are still recommended for glare reduction and improved comfort in bright light conditions.

Photochemical polymerization is a widely used method for forming contact lenses; however, the presence of photochromic dyes in a contact lens monomer mix can lead to incomplete photopolymerization.

### SUMMARY OF THE INVENTION

The present invention relates to a process comprising dosing a mixture comprising at least one lens forming component, at least one thermal initiator, at least one photoinitiator and at least one photochromic compound to an ophthalmic device mold; and curing said mixture under device forming conditions to form a photochromic ophthalmic device. More specifically, the present invention relates to a process comprising exposing a polymerizable mixture comprising at least one lens forming component, at least one thermal initiator, at least one photoinitiator and at least one photochromic compound to device forming conditions comprising heat and electromagnetic radiation to form a photochromic ophthalmic device.

### DETAILED DESCRIPTION OF THE INVENTION

It has been surprisingly found that a thermal and photochemical dual-initiated polymerization may be advantageously used to make photochromic contact lenses. The process of the present invention provides the convenience of a photocuring process, without the problems associated with incomplete cure which may result from partial interference from the photochromic compound.

As used herein the terms “lens” and “ophthalmic device” refer to devices that reside in or on the eye. These devices can provide optical correction, wound care, drug delivery, diagnostic functionality, cosmetic enhancement or effect or a combination of these properties. The term lens includes but is not limited to soft contact lenses, hard contact lenses, intraocular lenses, overlay lenses, ocular inserts, and optical inserts.

Suitable ophthalmic devices may be formed from a polymerizable mixture, or mixture, comprising at least one lens forming component, at least one photochromic compound, at least one thermal initiator and at least one photoinitiator. As used herein, the term “photochromic” means having an absorption spectrum for at least visible radiation that varies in response to absorption of at least actinic radiation. Further, as used herein, the term “photochromic material” or “photochromic compound” means any substance that is adapted to display photochromic properties, i.e., adapted to have an absorption spectrum for at least visible radiation that varies in response to absorption of at least electromagnetic radiation. Photochromic compounds are well known and several examples are described in “Organic Photochromic and Thermochromic Compounds: Main Photochromic Families (Topics in Applied Chemistry)“, by J. Crano and R. Guglielmetti, published by Plenum Publishing Corporation (Oct. 1, 1998). The photochromic materials can include the following classes of materials: chromenes, e.g., naphthopyrans, benzopyrans, indenonaphthopyrans and phenanthropyrans; spiropyrans, e.g., spiro(benzindoline)naphthopyrans, spiro(indoline)benzopyrans, spiro(indoline)naphthopyrans, spiro(indoline)quinopyrans and spiro(indoline)pyrans; oxazines, e.g., spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates, fulgides, fulgimides and mixtures of such photochromic compounds. Such photochromic compounds and complementary photochromic compounds are described in U.S. Pat. No. 4,931,220 at column 8, line 52 to column 22, line 40; U.S. Pat. No. 5,645,767 at column 1, line 10 to column 12, line 57; U.S. Pat. No. 5,658,501 at column 1, line 64 to column 13, line 17; U.S. Pat. No. 6,153,126 at column 2, line 18 to column 8, line 60; U.S. Pat. No. 6,296,785 at column 2, line 47 to column 31 line 5; U.S. Pat. No. 6,348,604 at column 3, line 26 to column 17, line 15; and U.S. Pat. No. 6,353,102 at column 1, line 62 to column 11, line 64. Spiro (indoline) pyrans are also described in the text, Techniques in Chemistry, Volume III, “Photochromism”, Chapter 3, Glenn H. Brown, Editor, John Wiley and Sons, Inc., New York, 1971. These references, and all others cited herein are hereby incorporated by reference.

In another non-limiting embodiment, other photochromic materials, that can be used include organo-metal dithiozonates, i.e., (arylazo)-thioformic arylhydrazidates, e.g., mercury dithizonates which are described in, for example, U.S. Pat. No. 3,361,706 at column 2, line 27 to column 8, line 43; and fulgides and fulgimides, e.g., the 3-furyl and 3-thienyl fulgides and fulgimides, which are describe din U.S. Pat. No. 4,931,220 at column 1, line 39 through column 22, line 41.

In another non-limiting embodiment, polymerizable photochromic materials, such as polymerizable naphthoxazines disclosed in U.S. Pat. No. 5,166,345 at column 3, line 36 to column 14, line 3; polymerizable spirobenzopyrans disclosed in U. S. Pat. No. 5,236,958 at column 1, line 45 to column 6, line 65; polymerizable spirobenzopyrans and spirobenzopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated napthopyrans disclosed in U.S. Pat. No. 6,113,814 at column 2, line 23 to column 23, line 29; and the polymerizable photochromic compounds disclosed in WO97/05213 and U.S. Pat. No. 6,555,028 can be used.

The photochromic materials used in the process of the present invention may be used alone or in combination with one or more other appropriate and complementary photochromic materials, e.g., organic photochromic compounds having at least one activated absorption maxima within the range of 400 and 700 nanometers, and which color when activated to an appropriate hue. Further discussion of neutral colors and ways to describe colors can be found in U.S. Pat. No. 5,645,767, column 12, line 66 to column 13, line 19.

Generally, the ophthalmic devices of the present invention are quite thin, with thicknesses across the optic zone of less than about 300, a frequently less than about 200 μm. Also, the amount of photochromic material which may be incorporated into the ophthalmic device material without degrading the properties of the resulting ophthalmic device, may be limited. Accordingly, photochromic materials which are efficient may be preferred.

An indication of the amount of radiation a material can absorb is the extinction coefficient of the material. The extinction coefficient (“ε”) of a material is related to the absorbance of the material by the following equation:
ε=A/(c×l)
wherein “A” is the absorbance of the material at a particular wavelength, “c” is the concentration of the material in moles per liter (mol/L) and “l” is the path length (or cell thickness) in centimeters (cm). Further, by plotting the extinction coefficient vs. wavelength and integrating over a range of wavelengths (e.g., =∫ε(λ)dλ) it is possible to obtain an “integrated extinction coefficient” for the material. Generally speaking, the higher the integrated extinction coefficient of a material, the more radiation the material will absorb on a per molecule basis. The photochromic materials according to various non-limiting embodiments disclosed herein may have an integrated extinction coefficient greater than 1.0×10⁶ nanometers per (mol×cm) or (nm×mol⁻¹×cm⁻¹) as determined by integration of a plot of extinction coefficient of the photochromic material vs. wavelength over a range of wavelengths ranging from 320 nm to 420 nm, inclusive. Further, the photochromic materials according to various non-limiting embodiments disclosed herein may have an integrated extinction coefficients of at least 1.1×10⁶ nm×mol⁻¹×cm⁻¹, or at least 1.3×10⁶ nm×mol⁻¹×cm⁻¹ as determined by integration of a plot of extinction coefficient of the photochromic material vs. wavelength over a range of wavelengths ranging from 320 nm to 420 nm, inclusive. For example, according to various non-limiting embodiments, the photochromic material may have an integrated extinction coefficient ranging from 1.1×10⁶ to 4.0×10⁶ nm×mol⁻¹×cm⁻¹ (or greater) as determined by integration of a plot of extinction coefficient of the photochromic material vs. wavelength over a range of wavelengths ranging from 320 nm to 420 nm, inclusive. However, as indicated above, generally speaking the higher the integrated extinction coefficient of a photochromic material, the more radiation the photochromic material will absorb on a per molecule basis. Accordingly, other non-limiting embodiments disclosed herein contemplate photochromic materials having an integrated extinction coefficient greater than 4.0 nm×mol⁻¹×cm⁻¹.

Still other non-limiting embodiments relate to ophthalmic devices comprising photochromic materials comprising: an indeno-fused naphthopyran chosen from an indeno[2′,3′:3,4]naphtho[1,2-b]pyran and an indeno[1′,2′:4,3]naphtho[2,1-b]pyran, wherein the 13-position of the indeno-fused naphthopyran is unsubstituted, mono-substituted or di-substituted, provided that if the 13-position of the indeno-fused naphthopyran is di-substituted, the substituent groups do not together form norbornyl; and (ii) a group that extends the pi-conjugated system of the indeno-fused naphthopyran bonded at the 11-position thereof, where said group is a substituted or unsubstituted aryl, a substituted or unsubstituted heteroaryl, or a group represented by —X═Y or —X′≡Y′, wherein X, X′, Y and Y′ are as described herein below and as set forth in the claims; or the group that extends the pi-conjugated system of the indeno-fused naphthopyran together with a group bonded at the 12-position of the indeno-fused naphthopyran or together with a group bonded at the 10-position of the indeno-fused naphthopyran form a fused group, provided the fused group is not a benzo fused group, which are more specifically disclosed in U.S. Ser. No. 11/______, entitled OPHTHALMIC DEVICES COMPRISING PHOTOCHROMIC MATERIALS HAVING EXTENDED PI-CONJUGATED SYSTEMS AND COMPOSITIONS AND ARTICLES INCLUDING THE SAME, filed on Apr. 8, 2005, and listing Beon-Kyu, Kim Jun Deng, Wenjing Xiao, Barry Van Gemert, Anu Chopra, Frank Molock and Shivkumar Mahadevan as inventors.

In another non-limiting embodiment the photochromic compounds are naphthopyrans shown in the formula below:

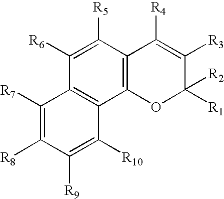

In which R₁, through R₁₀ may comprise H, a monosubstituted alkyl or aryl group, which may optionally comprise a heteroatom such as O, N or S, an alkenyl or alkynyl group, and which may in combination form fused or unfused rings, provided that one or more R group comprises a polymerizable group, such as a methacrylate, acrylate, acrylamide, methacrylamide, fumarate, styryl, N-vinyl amide group, preferably a methacrylate group, and wherein R₅ and R₆ may be fused to form an indeno naphthopyran. Specific non-limiting examples of suitable naphthopyran compounds include those described in:

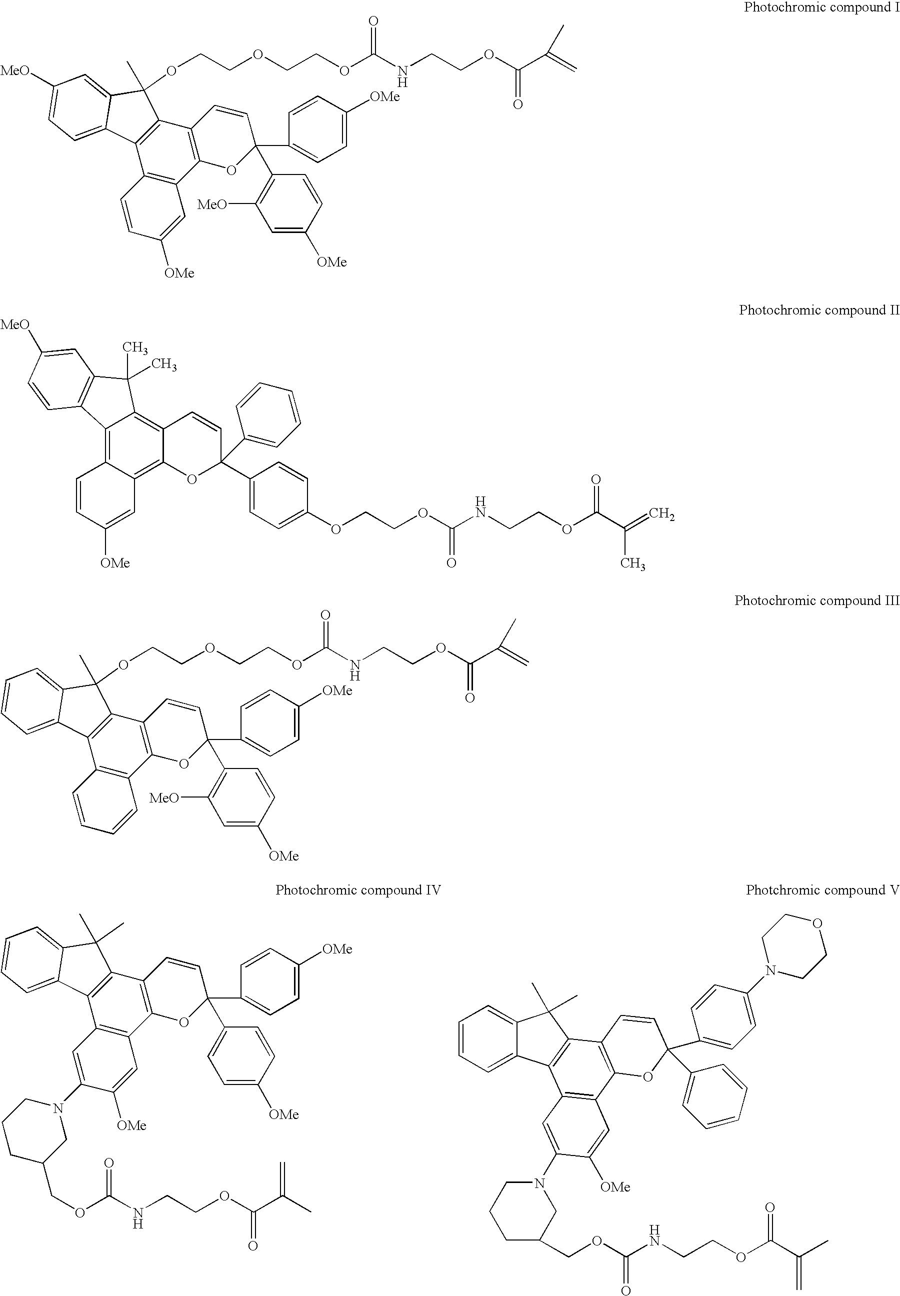

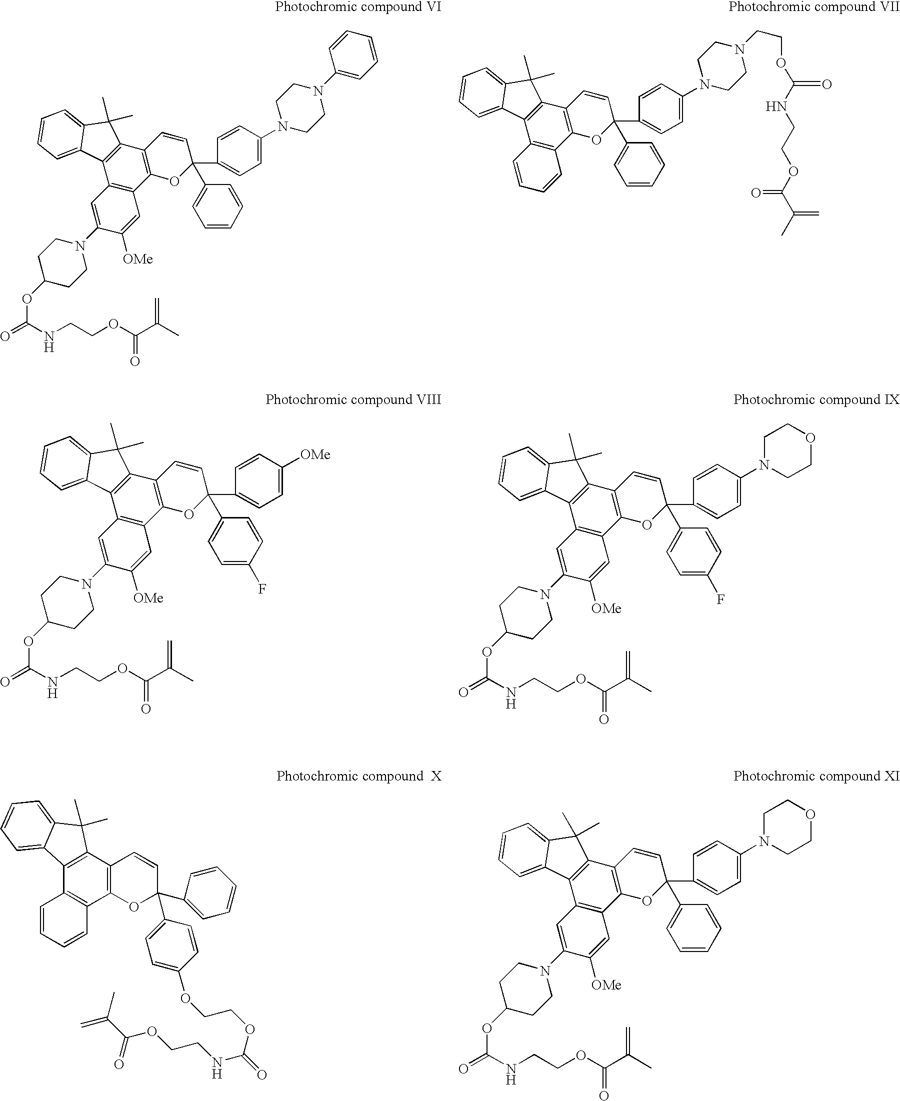

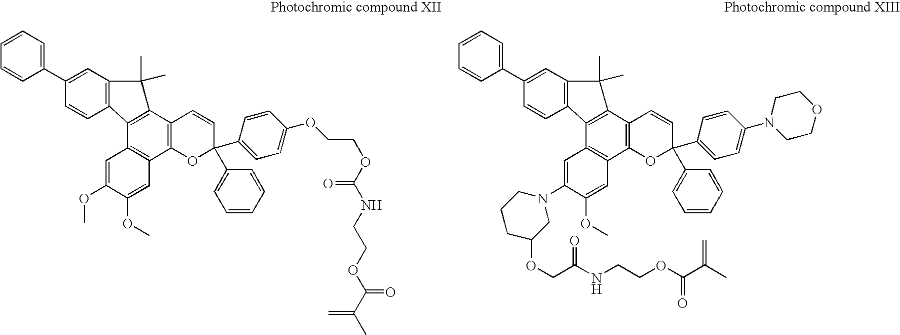

As used herein and in the claims, “photochromic amount” means an amount of photochromic material that is at least sufficient to produce a photochromic effect discernible to the naked eye upon activation. The particular amount used depends often upon the thickness of the contact lens, the intensity of color desired upon irradiation thereof. Typically, the more photochromic material incorporated, the greater the color intensity is up to a certain limit. There is a point after which the addition of any more material will not have a noticeable effect. The concentration of photochromic compound in the polymerizable mixture is selected based on a number of considerations such as the photochromic efficiency of the photochromic compound, the solubility of the photochromic compound in the polymerizable mixture, the thickness of the lens, and the desired darkness of the lens when exposed to light. Preferred concentrations of the photochromic compound in the polymerizable mixture are from about 0.1 to about 15 weight %, more preferably from about 1% to about 10 weight %, based upon the weight of all components in the polymerizable mixture.

The polymerizable mixture may include more than one photochromic compound.

The polymerizable mixture also comprises at least one photoinitiator and at least one thermal initiator. Generally suitable photoinitiators will absorb light in the range from 200 nm to about 700 nm. Depending on the absorbance spectra of the photochromic compound selected, suitable photoinitiators will absorb light in the range of about 200 to about 300 nm or about 400 to about 700 nm. Photoinitiators useful in this invention include aromatic alpha-hydroxy ketones, alkoxyoxybenzoins, acetophenones, acyl phosphine oxides, and a tertiary amine plus a diketone, mixtures thereof and the like. Illustrative examples of suitable photoinitiators are 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide (DMBAPO), bis(2,4,6-trimethylbenzoyl)-phenylphosphineoxide (Irgacure 819), 2,4,6-trimethylbenzyldiphenyl phosphine oxide and 2,4,6-trimethylbenzyoyl diphenylphosphine oxide, benzoin methyl ester and a combination of camphorquinone and ethyl 4-(N,N-dimethylamino)benzoate, mixtures thereof and the like. Commercially available visible light initiator systems include Irgacure® 819, Irgacure 1700, Irgacure® 1800, Irgacure® 819, Irgacure® 1850 (all from Ciba Specialty Chemicals) and Lucirin® TPO initiator (available from BASF). Commercially available UV photoinitiators include Darocur® 1173 and Darocur® 2959 (Ciba Specialty Chemicals).

Suitable cure intensities include between about 0.1 mW/cm² to about 10 mW/cm² and preferably between about 0.2 mW/cm² and 6 mW/cm², and more preferably between about 0.2 mW/cm² and 4 mW/cm². Suitable times for photocuring include from about 0.5 to about 30 minutes, preferably from about 1 minute to about 20 minutes.

Thermal initiators useful in this invention include compounds that generate free radicals at moderately elevated temperatures. Suitable classes of thermal initiators include, but are not limited to thermally labile azo compounds and peroxides. Non-limiting examples of thermally labile azo compounds include, but are not limited to, 2,2′-azobisisobutyronirile, 2,2′-azobis-2-methylbutyronitrile, 2,2′- azobis-2-methylvaleronitrile, 2,2′-azobis-2,3-dimethylbutyronitrile, 2, 2′-azobis-2-methylhexanenitrile, 2,2′-azobis-2,4-dimethylvaleronitrile, 2,2′-azobis-2,3,3-trimethylbutyronitrile, 2,2′-azobis-2-methylheptanenitrile, 2,2′- azobis-2-cyclopropylpropionitrile, 2,2′- azobis-2-cyclopentylpropionitrile, 2,2′-azobis-2-benzylpropionitrile, 2,2′-azobis-2-(4-nitrobenzyl)propionitrile, 2,2′-azobis-2-cyclobutylpropionitrile, 2,2′-azobis-2-cyclohexylpropionitrile, 2,2′- azobis-2-(4-chlorobenzyl)propionitrile, 2,2′-azobis-2-ethyl-3-methylvaleronitrile, 2,2′-azobis-2-isopropyl-3-methylvaleronitrile, 2,2′-azobis-2-isobutyl-4-methylvaleronitrile, 1,1′-azobis-1-cyclohexanenitrile, 1,1′-azobis-1-cyclobutanenitrile, 2,2′-azobis-2-carbomethoxypropionitrile, 2,2′-azobis-2-carboethoxypropionitrile, and combinations thereof and the like. Non-limiting examples of peroxides include, but are not limited to; cumene hydroperoxide, methyl ethyl ketone peroxide, cyclohexanone peroxide, bis-(1-oxycyclohexyl)peroxide, acetyl peroxide, capryl peroxide, lauroyl peroxide, stearoyl peroxide, benzoyl peroxide, p,p′-dichloro-benzoyl peroxide, (2,4,2′,4′-tetrachloro)-benzoyl peroxide, di-t-butyl peroxide, di-t-amyl peroxide, t-butyl-cumyl peroxide, dicumyl peroxide, 2,5-dimethyl-2,5-di(t-butyl peroxide)-hexane, t-butyl hydroperoxide, p-menthane hydroperoxide, 2,5-dimethyl-2,5-dihydroperoxide-hexane, t-butyl peracetate, t-butyl perisobutyrate, t-butyl perpivalate, t-butyl perbenzoate, di-t-butyl perphthalate, 2,5-dimethyl(2,5-benzoylperoxy)-hexane, t-butyl permaleate, i-propyl percarbonate, t-butylperoxy-i-propyl carbonate, succinic acid peroxide and combinations thereof and the like. In one embodiment, preferred initiator combinations include at least one thermal initiator selected from include lauryl peroxide, benzoyl peroxide, isopropyl percarbonate, azobisisobutyronitrile, mixtures thereof and the like.

Exemplary combinations include acyl phospine oxides and azobisisobutyronitrile. In one embodiment the thermal initiator comprises azobisisobutyronitrile and the photoinitiator is selected from bis(2,4,6-trimethylbenzoyl)-phenyl phosphine oxide, bis(2,6-dimethoxybenzoyl)-2,4-4-trimethylpentyl phosphine oxide, 2,4,6-trimethylbenzyldiphenyl phosphine oxide and 2,4,6-trimethylbenzyoyl diphenylphosphine oxide, and mixtures thereof In another embodiment the thermal initiator comprises azobisisobutyronitrile and the photoinitiator comprises bis(2,4,6-trimethylbenzoyl)-phenyl phosphine oxide. Combinations of more than two photoinitiators may also be used. For examples, in some embodiments it may be desirable to include at least one thermal initiator, and at least two photoinitiators, which absorb light in different parts of the electromagnetic spectrum. For example the at least two photoinitiators may comprise at least one photoinitiator which is activated in the visible light region, and at least one photoinitiator which is activated in the UV light region. A non-limiting example of a tertiary initiator system includes Irgacure 419, Irgacure 184 and AIBN.

Preferred amounts of photoinitiator to be added to the polymerizable mixture range from about 0.1 to about 5 weight %, preferably about 0.3 to about 3 weight %, and more preferably from about 0.3 to about 2 weight %. Preferred amounts of thermal initiator to be added to the polymerizable mixture range from about 0.01 to about 2 weight %, preferably about 0.1 to about 1 weight %. The precise amount of each initiator depends on the molar efficiency of each and on the temperature and the source and intensity of the light used to cure the lenses.

The temperature selected to effect the thermal cure of the lenses depends on the temperature-dependent rate of initiation of the specific thermal initiator used. Useful; temperatures may range from about 20 to about 150° C., more preferably from about 40 to about 100° C. The thermal cure time will vary with the temperature selected, with higher temperatures requiring less thermal cure time. Suitable thermal cure times include from about 1 minute to about 6 hours, and preferably from about 1 minute to about 3 hours.

The polymerizable mixture also includes at least one lens forming component. Suitable lens forming components include polymerizable and non-polymerizable components which are known in the art to be useful for forming lenses. Accordingly, lens forming components include polymerizable monomers, prepolymers and macromers, wetting agents, UV absorbing compounds, colorants, pigments and tints, mold release agents, processing aids, mixtures thereof and the like.

The lens forming components preferably form a hydrogel upon polymerization and hydration. A hydrogel is a hydrated, crosslinked polymeric system that contains water in an equilibrium state. Hydrogels typically are oxygen permeable and biocompatible, making them preferred materials for producing ophthalmic devices and in particular contact or intraocular lenses.

Lens forming components are known in the art and include polymerizable monomers, prepolymers and macromers which contain polymerizable group(s) and performance groups which provide the resulting polymer with desirable properties. Suitable performance groups include hydrophilic groups, oxygen permeability enhancing groups, UV or visible light absorbing groups, combinations thereof and the like.

The term “monomer” used herein refers to low molecular weight compounds (i.e. typically having number average molecular weights less than about 700). Prepolymers are medium to high molecular weight compounds or polymers (having repeating structural units and a number average molecular weight greater than about 700) containing functional groups capable of further polymerization. Macromers are non-cross-linked polymers which are capable of cross-linking, polymerization or copolymerization.

Hydrophilic components include those which are capable of providing at least about 20% and preferably at least about 25% water content to the resulting lens when combined with the remaining reactive components. The hydrophilic monomers that may be used to make the polymers of this invention have at least one polymerizable double bond and at least one hydrophilic functional group. Examples of polymerizable double bonds include acrylic, methacrylic, acrylamido, methacrylamido, fumaric, maleic, styryl, isopropenylphenyl, O-vinylcarbonate, O-vinylcarbamate, allylic, O-vinylacetyl and N-vinyllactam and N-vinylamide double bonds. Non-limiting examples of hydrophilic monomers having acrylic and methacrylic polymerizable double bonds include N,N-dimethylacrylamide (DMA), 2-hydroxyethyl acrylate, 2-hydroxyethyl methacrylate, glycerol methacrylate, 2-hydroxyethyl methacrylamide, polyethyleneglycol monomethacrylate, methacrylic acid, acrylic acid and mixtures thereof.

Non-limiting examples of hydrophilic monomers having N-vinyl lactams and N-vinylamides polymerizable double bonds include N-vinyl pyrrolidone (NVP), N-vinyl-N-methyl acetamide, N-vinyl-N-ethyl acetamide, N-vinyl-N-ethyl formamide, N-vinyl formamide, N-2-hydroxyethyl vinyl carbamate, N-carboxy-B-alanine N-vinyl ester, with NVP and N-vinyl-N-methyl acetamide being preferred.

Other hydrophilic monomers that can be employed in the invention include polyoxyethylene polyols having one or more of the terminal hydroxyl groups replaced with a functional group containing a polymerizable double bond.

Still further examples are the hydrophilic vinyl carbonate or vinyl carbamate monomers disclosed in U.S. Pat. No. 5,070,215, and the hydrophilic oxazolone monomers disclosed in U.S. Pat. No. 4,190,277. Other suitable hydrophilic monomers will be apparent to one skilled in the art.

Preferred hydrophilic monomers which may be incorporated into the polymerizable mixture of the present invention include hydrophilic monomers such as N,N-dimethyl acrylamide (DMA), 2-hydroxyethyl acrylate, 2-hydroxyethyl methacrylate (HEMA), glycerol methacrylate, 2-hydroxyethyl methacrylamide, N-vinylpyrrolidone (NVP), N-vinyl-N-methyl acetamide, polyethyleneglycol monomethacrylate, and mixtures thereof.

Most preferred hydrophilic monomers include HEMA, DMA, NVP, N-vinyl-N-methyl acetamide and mixtures thereof.

The above referenced hydrophilic monomers are suitable for the production of conventional contact lenses such as those made from to etafilcon, polymacon, vifilcon, genfilcon A and lenefilcon A and the like. Alternatively, suitable contact lenses may be made from materials having increased permeability to oxygen, such as galyfilcon A, senofilcon A, balafilcon, lotrafilcon A and B and the like. The polymerization mixtures used to form these and other materials having increased permeability to oxygen, generally include one or more of the hydrophilic monomers listed above, with at least one silicone containing component.

A silicone-containing component is one that contains at least one [—Si—O—Si] group, in a monomer, macromer or prepolymer. Preferably, the Si and attached 0 are present in the silicone-containing component in an amount greater than 20 weight percent, and more preferably greater than 30 weight percent of the total molecular weight of the silicone-containing component. Useful silicone-containing components preferably comprise polymerizable functional groups such as acrylate, methacrylate, acrylamide, methacrylamide, N-vinyl lactam, N-vinylamide, and styryl functional groups. Examples of silicone-containing components which are useful in this invention may be found in U.S. Pat. Nos. 3,808,178; 4,120,570; 4,136,250; 4,153,641; 4,740,533; 5,034,461 and 5,070,215, and EP080539. All of the patents cited herein are hereby incorporated in their entireties by reference. These references disclose many examples of olefinic silicone-containing components.

Further examples of suitable silicone-containing monomers are polysiloxanylalkyl(meth)acrylic monomers represented by the following formula: 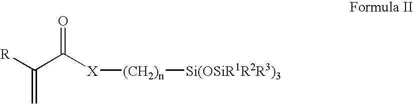
wherein: R denotes H or lower alkyl; X denotes O or NR⁴; each R⁴ independently denotes hydrogen or methyl,

each R¹-R³ independently denotes a lower alkyl radical or a phenyl radical, and n is 1 or 3 to 10.

Examples of these polysiloxanylalkyl (meth)acrylic monomers include methacryloxypropyl tris(trimethylsiloxy) silane, methacryloxymethylpentamethyldisiloxane, methacryloxypropylpentamethyldisiloxane, methyldi(trimethylsiloxy)methacryloxypropyl silane, and methyldi(trimethylsiloxy)methacryloxymethyl silane. Methacryloxypropyl tris(trimethylsiloxy)silane may be preferred in embodiments where a polysiloxanylalkyl(meth)acrylic monomers is included.

One preferred class of silicone-containing components is a poly(organosiloxane) prepolymer represented by Formula III: 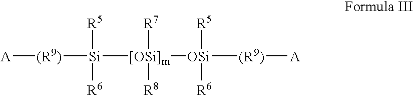
wherein each A independently denotes an activated unsaturated group, such as an ester or amide of an acrylic or a methacrylic acid or an alkyl or aryl group (providing that at least one A comprises an activated unsaturated group capable of undergoing radical polymerization); each of R⁵, R⁶, R⁷ and R⁸ are independently selected from the group consisting of a monovalent hydrocarbon radical or a halogen substituted monovalent hydrocarbon radical having 1 to 18 carbon atoms which may have ether linkages between carbon atoms;

R⁹ denotes a divalent hydrocarbon radical having from 1 to 22 carbon atoms, and

m is 0 or an integer greater than or equal to 1, and preferably 5 to 400, and more preferably 10 to 300. One specific example is α, ω-bismethacryloxypropyl poly-dimethylsiloxane. Another preferred example is mPDMS (monomethacryloxypropyl terminated mono-n-butyl terminated polydimethylsiloxane).

Another useful class of silicone containing components includes silicone-containing vinyl carbonate or vinyl carbamate monomers of the following formula: 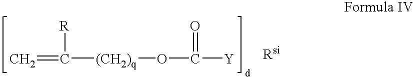
wherein: Y denotes O, S, or NH; R^{Si} denotes. a silicone-containing organic radical; R denotes hydrogen or methyl; d is 1, 2, 3 or 4; and q is 0 or 1. Suitable silicone-containing organic radicals R^{Si} include the following: 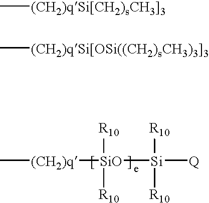
wherein:

Q denotes

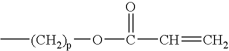

wherein p is 1 to 6; R10 denotes an alkyl radical or a fluoroalkyl radical having 1 to 6 carbon atoms; e is 1 to 200; q′ is 1, 2, 3 or 4; and s is 0, 1, 2, 3, 4 or 5.

The silicone-containing vinyl carbonate or vinyl carbamate monomers specifically include: 1,3-bis[4-(vinyloxycarbonyloxy)but-1-yl]tetramethyl-disiloxane; 3-(vinyloxycarbonylthio)propyl-[tris(trimethylsiloxy)silane]; 3-[tris(trimethylsiloxy)silyl]propyl allyl carbamate; 3-[tris(trimethylsiloxy)silyl]propyl vinyl carbamate; trimethylsilylethyl vinyl carbonate; trimethylsilylmethyl vinyl carbonate, and

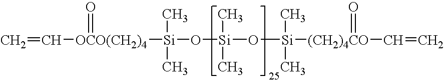

The above description of silicone containing components is not an exhaustive list. Any other silicone components known in the art may be used. Further examples include, but are not limited to macromers formed by group transfer polymerization, such as those disclosed in U.S. Pat. No. 6,367,929, polysiloxane containing polyurethane compounds such as those disclosed in U.S. Pat. No. 6,858,218, polysiloxane containing macromers, such as those described as Materials A-D in U.S. Pat. No. 5,760,100; macromers containing polysiloxane, polyalkylene ether, diisocyanate, polyfluorinated hydrocarbon, polyfluorinated ether and polysaccharide groups, such as those described is WO 96/31792; polysiloxanes with a polar fluorinated graft or side group(s) having a hydrogen atom attached to a terminal difluoro-substituted carbon atom, such as those described in U.S. Pat. Nos. 5,321,108; 5,387,662 and 5,539,016; hydrophilic siloxanyl methacrylate monomers and polysiloxane-dimethacrylate macromers such as those described in US 2004/0192872; combinations thereof and the like.

The polymerizable mixture may contain additional components such as, but not limited to, wetting agents, such as those disclosed in U.S. Pat. No. 6,822,016, U.S. Ser. No. 11/057,363, U.S. Ser. No. 10/954560, U.S. Ser. No. 10/954,559 and U.S. Ser. No. 10/955,214; UV absorbers, medicinal agents, antimicrobial compounds, reactive tints, pigments, copolymerizable and nonpolymerizable dyes, release agents, silicone containing compatibilizing components, such as reaction components which contain at least one silicone and at least one hydroxyl group, as described in WO03/022321 and WO03/022322 and combinations thereof.

The polymerizable mixture may optionally further comprise a diluent. Suitable diluents for polymerizable mixtures are well known in the art. Preferred diluents for conventional hydrogel systems include organic solvents or water or mixtures hereof. Preferred organic solvents include alcohols, diols, triols, polyols and polyalkylene glycols. Examples include but are not limited to glycerin, diols such as ethylene glycol or diethylene glycol; boris acid esters of polyols such as those described in U.S. Pat. Nos. 4,680,336; 4,889,664 and 5,039,459; and polyvinylpyrrolidone. Diluents can also be selected from the group having a combination of a defined viscosity and Hanson cohesion parameter as described in U.S. Pat. No. 4,680,336.

Non-limiting examples of diluents for use with silicone hydrogel formulations include U.S. Pat. No. 6,020,445 and U.S. Ser. No. 10/794,399. The disclosure of these and all other references cited within this application are hereby incorporated by reference. Many other suitable examples are known to those of skill in the art and are included within the scope of this invention.

Hard contact lenses are made from polymers that include but are not limited to polymers of poly(methyl)methacrylate, silicon acrylates, fluoroacrylates, fluoroethers, polyacetylenes, and polyimides, where the preparation of representative examples may be found in U.S. Pat. Nos. 4,540,761; 4,508,884; 4,433,125 and 4,330,383. Intraocular lenses of the invention can be formed using known materials. For example, the lenses may be made from a rigid material including, without limitation, polymethyl methacrylate, polystyrene, polycarbonate, or the like, and combinations thereof. Additionally, flexible materials may be used including, without limitation, hydrogels, silicone materials, acrylic materials, fluorocarbon materials and the like, or combinations thereof. Typical intraocular lenses are described in WO 0026698, WO 0022460, WO 9929750, WO 9927978 and WO 0022459. Other ophthalmic devices, such as punctal plugs may be made from collagen and silicone elastomers.

In a typical procedure, the polymerizable mixture is made using a combination of one or more photoinitiator and one or more thermal initiator along with at least one lens forming component and at least one photochromic compound. This polymerizable mixture is photochemically cured in an ophthalmic device mold. The thermal cure is initiated either concurrently with the photocuring, or after the photocuring is complete. Conditions for the thermal/photocure are as described above.

When the ophthalmic device is a contact lenses the preferred method of production is placing the uncured formulation in a mold, curing and subsequently hydrating. Various processes are known for molding the polymerizable mixture in the production of contact lenses, including spincasting and static casting. Spincasting methods are disclosed in U.S. Pat. No. Nos. 3,408,429 and 3,660,545, and static casting methods are disclosed in U.S. Pat. No. Nos. 4,113,224 and 4,197,266. The preferred method for producing contact lenses comprising the polymer of this invention is by the direct molding of the hydrogels, which is economical, and enables precise control over the final shape of the hydrated lens. For this method, the reaction mixture is placed in a mold having the shape of the final desired ophthalmic device, and the reaction mixture is subjected to conditions whereby the polymerizable mixture polymerizes, to thereby produce a polymer in the approximate shape of the final desired product. Then, this polymer mixture is optionally treated with a solvent and then water, producing a hydrogel having a final size and shape which are quite similar to the size and shape of the original molded polymer article. This method can be used to form contact lenses and is further described in U.S. Pat. Nos. 4,495,313; 4,680,336; 4,889,664; and 5,039,459.

If the lenses are cured using only thermal polymerization or only photochemical polymerization then incomplete and inconsistent cure may result, leading to lenses that suffer from poor mechanical properties, poor optics, or sticky surfaces, are misshapen, or in some cases are not even strong enough to be released from the molds.

These examples do not limit the invention. They are meant only to suggest a method of practicing the invention. Those knowledgeable in contact lenses as well as other specialties may find other methods of practicing the invention. However, those methods are deemed to be within the scope of this invention.

The following abbreviations are used in the examples below.
HEMA 2-hydroxyethyl methacrylate
EGDMA ethyleneglycol dimethacrylate
TMPTMA trimethylolpropane trimethacrylate
MAA methacrylic acid
CGI 819 bis(2,4,6-trimethylbenzoyl)-phenyl phosphine oxide
AIBN 2,2′-azobisisobutyronitrile
Tweene 80 polyoxyethylene(20) sorbitan monooleate
Glucam E-20 poly(oxy-1,2-ethanediyl), .alpha.-hydro-.omega.-hydroxy-, ether with methyl D-glucopyranoside, Ave. MW 1074 g/mole
   Photochromic Compound Synthesis

Photochromic compound V was produced as follows.

Step 1

Step 1

2,3-Dimethoxy-7,7-dimethyl-7H-benzo[C]fluoren-5-ol (10 g), 1-phenyl-1-(4-morpholinophenyl)-2-propyn-1-ol (13 g), dodecyl benzenesulfonic acid (10 drops), and chloroform (400 mL) were combined in a reaction flask. The reaction mixture was heated at reflux for 3 hours and concentrated. Acetone was added to the residue, and the slurry was filtered, yielding 18 g of off-white solid.

Step 2

3-Phenyl-3-(4-morpholinophenyl)-6,7-dimethoxy-13,13-dimethyl-3H, 13H-indeno[2′,3′:3,4]naphtho[1,2-b]pyran from Step 1 (20 g), 4-hydroxypiperidine (7.6 g), and tetrahydrofuran (250 mL) were combined in a dry reaction flask cooled with ice bath under nitrogen atmosphere. Butyl lithium in hexane (2.5 M, 50 mL) was added to the reaction mixture dropwise under stirring. The cooling bath was removed after the addition and the flask was warmed to room temperature. The dark solution was poured into ice water (400 mL) and the mixture was extracted with ethyl acetate (twice with 400 mL). The organic layer was washed with saturated sodium chloride aqueous solution (200 mL), dried over sodium sulfate and concentrated. The residue was purified by silica gel chromatography (ethyl acetate/hexanes (v/v): 1/1.5). The product was obtained as off-white crystals.

Step 3

3-phenyl-3-(4-morphlinophenyl)-6-methoxy-7-(4-hydroxypiperidin-1-yl)-13,13-dimethyl-3H,13H-indeno[2′,3′:3,4]naphtho[1,2-b]pyran (from Step 1) (9 g), 2-isocyanatoethyl methacrylate (3 mL), dibutyltin laureate (5 drops) and ethyl acetate (200 mL) were combined in a reaction flask with a condenser open to air. The mixture was heated at reflux for 30 minutes. Methanol (15 mL) was added to the mixture to quench excess 2-isocyanatoethyl methacrylate. The reaction mixture was concentrated and the residue was purified by silica gel chromatography (ethyl acetate/hexanes (v/v): 1/1). The product was obtained as purple-tinted crystals. Mass spectrometry supports the molecular weight of 3-phenyl-3-(4-morphlinophenyl)-6-methoxy-7-(4-(2-methacryloxyethyl)carbamyloxypiperidin-1-yl)-13,13-dimethyl-3H, 13H-indeno[2′,3′:3,4]naphtho[1,2-b]pyran.

### EXAMPLE 1

Under a nitrogen atmosphere, about 100 mg of a blend of 91% (wt) HEMA, 2.2% MAA, 0.83% EGDMA, 0.1% TMPTMA, 0.55% AIBN and 0.5% CGI 819, and 5.25% photochromic compound V, prepared above, was combined with Glucam E-20 diluent in a ratio of 50 weight parts diluent to 50 weight parts reactive monomers, and placed into each front curve mold. Back curve molds were placed onto the front curve molds and lenses were formed by curing the mixture under visible light from fluorescent bulbs (Philips TLK03/40W) for about 20 minutes at about 50° C. The molds were removed from the light and placed in an oven that was heated to 70° C. for about 3 hours. The molds were removed from the oven and promptly pried open while still hot. The lenses were released from the molds by immersing them in an aqueous solution of 0.16 weight % disodium EDTA and 0.02 weight % Tween® 80 at about 70° C. for about 30 minutes. The lenses were rinsed in borate-buffered saline solution. The final lenses were uniform in shape.

### COMPARATIVE EXAMPLE

Lenses were made using the process of the above example, except with 1.0% CGI 819, omitting the AIBN (thermal initiator), and without the 3 hour heating step. After hydration the lenses were misshapen.

We claim:

1. A process comprising exposing a polymerizable mixture comprising at least one lens forming component, at least one thermal initiator, at least one photoinitiator and at least one photochromic compound to device forming conditions comprising heat and actinic radiation to form a photochromic ophthalmic device.

2. The process of claim 1 wherein said at least one photoinitiator absorbs light in the range from 200 nm to about 700 nm.

3. The process of claim 1 wherein said at least one photoinitiator absorbs light in the range of about 200 to about 300 nm.

4. The process of claim 1 wherein said at least one photoinitiator absorbs light in the range of or about 400 to about 700 nm.

5. The process of claim 1 wherein said at least one photoinitiator is selected from the group consisting of aromatic alpha-hydroxy ketones, alkoxyoxybenzoins, acetophenones, acyl phosphine oxides, and a tertiary amine plus a diketone, and mixtures thereof.

6. The process of claim 1 wherein said at least one photoinitiator is selected from the group consisting of 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide, bis(2,4,6-trimethylbenzoyl)-phenylphosphineoxide, 2,4,6-trimethylbenzyldiphenyl phosphine oxide and 2,4,6-trimethylbenzyoyl diphenylphosphine oxide, benzoin methyl ester and a combination of camphorquinone and ethyl 4-(N,N-dimethylamino)benzoate and mixtures thereof.

7. The process of claim 1 wherein said at least one thermal initiators is selected from the group consisting of thermally labile azo compounds, peroxides and combinations thereof.

8. The process of claim 1 wherein said at least one thermal initiators is selected from the group consisting of 2,2′-azobisisobutyronirile, 2,2′-azobis-2-methylbutyronitrile, 2,2′-azobis-2-methylvaleronitrile, 2,2′-azobis-2,3-dimethylbutyronitrile, 2,2′-azobis-2-methylhexanenitrile, 2,2′-azobis-2,4-dimethylvaleronitrile, 2,2′-azobis-2,3,3-trimethylbutyronitrile, 2,2′-azobis-2-methylheptanenitrile, 2,2′-azobis-2-cyclopropylpropionitrile, 2,2′-azobis-2-cyclopentylpropionitrile, 2,2′-azobis-2-benzylpropionitrile, 2,2′-azobis-2-(4-nitrobenzyl)propionitrile, 2,2′-azobis-2-cyclobutylpropionitrile, 2,2′-azobis-2-cyclohexylpropionitrile, 2,2′-azobis-2-(4-chlorobenzyl)propionitrile, 2,2′-azobis-2-ethyl-3-methylvaleronitrile, 2,2′-azobis-2-isopropyl-3-methylvaleronitrile, 2,2′-azobis-2-isobutyl-4-methylvaleronitrile, 1,1′-azobis-1-cyclohexanenitrile, 1,1′-azobis-1-cyclobutanenitrile, 2,2′-azobis-2-carbomethoxypropionitrile, 2,2′-azobis-2-carboethoxypropionitrile, cumene hydroperoxide, methyl ethyl ketone peroxide, cyclohexanone peroxide, bis-(1-oxycyclohexyl)peroxide, acetyl peroxide, capryl peroxide, lauroyl peroxide, stearoyl peroxide, benzoyl peroxide, p,p′-dichloro-benzoyl peroxide, (2,4,2′,4′-tetrachloro)-benzoyl peroxide, di-t-butyl peroxide, di-t-amyl peroxide, t-butyl-cumyl peroxide, dicumyl peroxide, 2,5-dimethyl-2,5-di(t-butyl peroxide)-hexane, t-butyl hydroperoxide, p-menthane hydroperoxide, 2,5-dimethyl-2,5-dihydroperoxide-hexane, t-butyl peracetate, t-butyl perisobutyrate, t-butyl perpivalate, t-butyl perbenzoate, di-t-butyl perphthalate, 2,5-dimethyl(2,5-benzoylperoxy)-hexane, t-butyl permaleate, i-propyl percarbonate, t-butylperoxy-i-propyl carbonate, succinic acid peroxide and combinations thereof and the like.

9. The process of claim 1 wherein said at least one thermal initiator is selected from the group consisting lauryl peroxide, benzoyl peroxide, isopropyl percarbonate, azobisisobutyronitrile and mixtures thereof.

10. The process of claim 1 wherein said at least one thermal initiator comprises azobisisobutyronitrile and said at least one photoinitiator comprises at least one acyl phosphine oxide.

11. The process of claim 1 wherein said at least one thermal initiator comprises azobisisobutyronitrile and said at least one photoinitiator is selected from the group consisting of bis(2,4,6-trimethylbenzoyl)-phenyl phosphine oxide, bis(2,6-dimethoxybenzoyl)-2,4-4-trimethylpentyl phosphine oxide, 2,4,6-timethylbenzyldiphenyl phosphine oxide and 2,4,6-trimethylbenzyoyl diphenylphosphine oxide, and mixtures thereof

12. The process of claim 1 wherein said at least one thermal initiator comprises azobisisobutyronitrile and said at least one photoinitiator comprises bis(2,4,6-trimethylbenzoyl)-phenyl phosphine oxide.

13. The process of claim 1 wherein said photoinitiator is present in an amount from about 0.1 to about 5 weight %, based upon the total weight of the polymerizable mixture.

14. The process of claim 1 wherein said photoinitiator is present in an amount from about 0.3 to about 2 weight %, based upon the total weight of the polymerizable mixture.

15. The process of claim 1 wherein said thermal initiator is present in an amount from about 0.1 to about 2 weight %, based upon the total weight of the polymerizable mixture. Preferred amounts of thermal initiator to be added to the polymerizable mixture.

16. The process of claim 15 wherein said thermal initiator is present in an amount from about 0.1 to about 2 weight %, based upon the total weight of the polymerizable mixture.

17. The process of claim 1 wherein said device forming conditions comprise a temperature between about 20 to about 150° C.

18. The process of claim 1 wherein said device forming conditions comprise a temperature between about 40 to about 100° C.

19. The process of claim 17 wherein said device forming conditions comprise a thermal cure time from about 1 minute to about 6 hours.

20. The process of claim 1 wherein said ophthalmic device is a soft contact lens.

21. The process of claim 1 further comprising the step of introducing said polymerizable mixture into said mold or onto a portion of said lens mold.

22. The process of claim 1 wherein said device forming conditions comprise irradiation in the range of about 200 to about 700 nm.

23. The process of claim 1 wherein said device forming conditions comprise irradiation in the range of about 200 to about 300 nm.

24. The process of claim 1 wherein said device forming conditions comprise irradiation in the range of about 400 to about 700 nm.
